(19) United States
(12) Patent Application Publication
(10) Pub. No.: US 2007/0244758 A1
(43) Pub. Date: Oct. 18, 2007

(54) Methods and systems for managing information relevant to shopping tasks

(76) Inventor: Bin Xie, Austin, TX (US)

Correspondence Address: BIN XIE, 3301 ROLLER CROSSING, AUSTIN, TX, 78728, US

(21) Appl. No.: 11/735,828

(22) Filed: Apr. 16, 2007

Related U.S. Application Data
(60) Provisional application No. 60/744,936, filed on Apr. 16, 2006.

(51) Int. Cl. G06Q 30/00

(52) U.S. Cl. 705/14; 705/26

(57) ABSTRACT

This invention relates to methods and systems of helping consumers to manage their shopping tasks with an internet based shopping task management service. Shopping related information along with other information collected by said service is taken into consideration in the process of selecting relevant advertising information. Selected advertising information is then presented to consumers through said service. Consumer reactions to presented advertising information as well as other information obtained by consumers are collected, stored and made available for consumers to process.

This application claims the benefit of U.S. Provisional Application Ser. No. 60744936 filed Apr. 16 2006 pending. The subject matter of Provisional Application Ser. No. 60744936 is incorporated herein by reference.

### BACKGROUND OF THE INVENTION

This invention relates to methods and systems of providing internet based shopping task management service to consumers. With which, consumers can create accounts, create, read, update and delete shopping tasks in an account. Shopping task accounts are shareable by a plurality of users. In addition, this service includes novel functions such as selecting and presenting targeted advertising information; storing consumer reactions to presented advertising information; and storing information collected by consumers from other sources.

In this application, shopping list is a term interchangeable with shopping task list which contains a list of shopping tasks. Each shopping task is associated with one product or service to be acquired or to be evaluated before a decision is reached. Shopping task contains or is linked to a set of related information all associated with the process of evaluating and acquiring this single product or service. This set of information comprising any or any combination of, and is not limited to, name of the service or product, the model number, the maker, the reseller, schedule, consumer comments, consumer reactions to advertising information, consumer collected information, plan of action, questions and etc.

Shopping related information mentioned in this application, in general, includes one or more of the followings but is not limited to: intentions, planning, status and history of acquiring certain products or services; information about consumers and their activities which could enable venders of related products or services to anticipate the needs of their products or services information about consumer preferences or requirements on products or services, and so on.

Shopping related information for a shopping task management account includes all shopping task information of every task on the list.

Consumer mentioned in this application in general includes one or more of the followings: individual person, groups of individuals such as families, or organizations such as companies who might be in need of products or services. User of the shopping task management service and consumer are interchangeable terms in this application.

Advertising information mentioned in this application includes one or more of the followings and is not limited to: product or service information, availability of product or service, location or timing of the product or service, price information, discount information, gift information, coupon and other information designed to attract consumer attention or patronage. Relevant advertising information mentioned in this application refers to and is not limited to advertising information which promotes the same, similar, alternative, related, competing supplementing or substituting products or services to those services or products that consumers are about to acquire, or presumed to about to acquire. It can also be the advertising information which sponsors or application server assumes to be of interest to consumers. Relevant advertising information usually has perceived associations, determined by said service or sponsors, with certain shopping related information including customer information and shopping task information collected by said service.

In this application, targeted advertising information refers to, but is not limited to, those advertising information entries which advertising sponsors or application server has decided that they relevant advertising information and selected to be presented to any or any combination of, and is not limited to, a shopping task list, a group of shopping task lists, a user, a group of users, a shopping task, a group of shopping tasks.

Advertising information could be in form of and is not limited to text, image, audio, video, animation, SMS (short message service), MMS (multimedia message service), email, instant message, chat, web page, prints, TV and other formats or the combination of above mentioned.

In this application, user reaction includes any or any combination of, and is not limited to, decision to buy, to gather more information, to delay, to act immediately, to look for help; suggestions; questions; specifying preferences on one or more the product or service's characteristic, feature, vendor, venue, model, color; and many others. User comment and user reaction are interchangeable terms, while in some non-limiting cases, comment is mostly stored in form of text while a user reaction could be stored in form of a database record.

Said shopping task management service is fully functional and useful to consumers even if there is no advertising information selected and presented.

Electronic device mentioned in this application includes but is not limited to the followings: computers, cell phones, PDAs, printers, GPS receivers and other devices that include appropriate hardware and software components for processing information. Wireless device in general includes but is not limited to wireless cell phones, computers with wireless WAN connections, computers with wireless LAN connections, or other electronic devices capable of connecting to wireless networks.

Web page mentioned this application includes but not limited to web page which would be opened and interacted with through browser running on electronic devices such desktop computers, notebook computers, cell phones, GPS receivers and PDAs.

Shopping tasks are usually generated over a period of time at different places, at different times and by different people in random orders. The action of acquiring certain product or service is generally carried out by a smaller group of people within a shorter period of time at certain locations. This behavior pattern holds true for many families and companies in the US and other countries. In many cases, people who carry out the task of acquiring services or products tend to write down or print out shopping tasks, and check off those items once the tasks are done. Collecting and managing shopping task information from different persons over a period of time is not a trivial chore for many people.

For high price items or services, consumers usually spend more time collecting pertinent product/service information, comparing prices, comparing services rendered by retailer and manufacturers. These activities generate original information from various sources. There are also consumer comments, decisions associated with or referencing said original information. Both need to be stored, organized and presented during the process of acquiring goods or services.

Product or service vendors want to send their advertising information targeting potential customers close to the moment customers are ready to make the decision or to carry out the procurement action. For venders, there is no easy way to identify shopping related information such as potential customers, moment of purchase decision, location of the purchase, brand under consideration and etc. Therefore, a lot of money is wasted on blanket advertisements that do not reach intended customers at the right moment or right location.

Most consumers would welcome limited amount of advertising information directly related to their shopping needs. Consumers usually don't take the effort of providing potential suppliers their own shopping related information mainly due to concern of privacy, cost of communication and convenience of such action.

Up to the present, there are plenty of websites helping consumers to compare prices or presenting additional information for a product or service. But most of them lack key features which would address the need of storing and managing consumer generated or consumer collected information during the process of acquiring a product or service.

It is therefore desirable to provide methods and systems to enable a 3^{rd} party shopping task management service on the internet which achieves the followings:
Allows consumers to manage and share their shopping task information conveniently and frequently.
Allows product or service vendors to select and present advertising information to consumers based on information collected from such service including shopping related information.
Preserves consumer privacy and gives consumers certain control of how and what advertising information are presented.
Pertinent information collected by consumers is stored and made available for processing.
Pertinent consumer reactions, comments and decisions for a certain shopping task are store and made available for processing.

The above mentioned desirable features and objects are achieved in the present invention wherein methods and systems are set forth.

It should be understood that there are many possible embodiments of the present invention. The embodiments presented below are considered to be the best practices at the time this application is filed.

In the following description, the present invention is directed to an exemplary application server comprising the following subsystems:
A web based service, accessible through internet or wireless network by computers, wireless devices or other electronic devices, provides functions allowing consumers to open and maintain shopping task management accounts. Within each account, users can create, read, and update shopping tasks. Each account could be shared by a plurality of users, and members of the account can create, read, and update shopping tasks on that account as permitted by account policy. This service allows users to store electronic information associated with shopping tasks. This service allows users to store their reactions, comments and other decision making information associated with shopping tasks.
A software component to search for relevant advertising information based on collected information including shopping related information from such service.
A software component to present selected advertisement information on same web page where consumers use said services.
A software component to transmit consumer selected shopping tasks and advertising information in compatible message formats to electronic devices including wireless devices or printers designated by consumers.

It is important to note that in other embodiments, said application server or servers may comprise different sets of subsystems.

### BRIEF DESCRIPTION OF THE DRAWINGS

Advantages of the present invention may be better understood by referring to the following description taken in conjunction with the accompanying drawings, in which:

FIG. 1 is a simplified block diagram of a set of external systems with which an exemplary application server of the present invention will interact; and

FIG. 2 is a simplified block diagram illustrating subsystems of the application server of FIG. 1.

FIG. 3 is an example of a shopping task list as customers adding new tasks in random order.

FIG. 4 is an example of a shopping task list after being revised by consumers.

FIG. 5 contains examples of a sent shopping task list with and without embedded advertising information in SMS format.

### DETAILED DESCRIPTION OF PREFERRED EMBODIMENTS

The Shopping Task Management Service

It should be apparent that the figures and descriptions of the present invention have been simplified to illustrate elements and methods that are relevant for a clear understanding of the present invention. Persons skilled in the art will recognize those well understood elements and methods of a typical website, database and software system. Therefore detail discussion of such elements and methods are not provided herein.

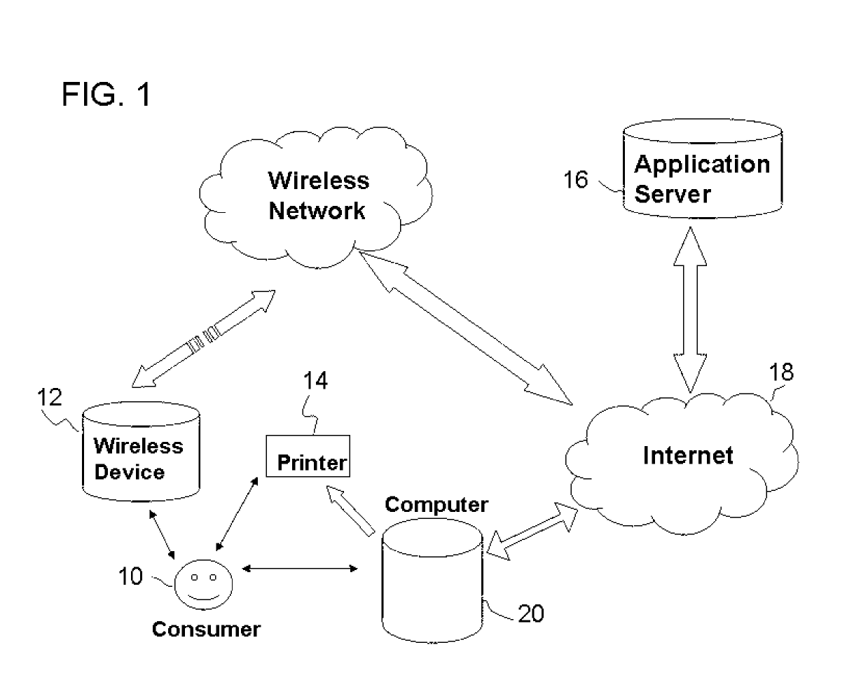

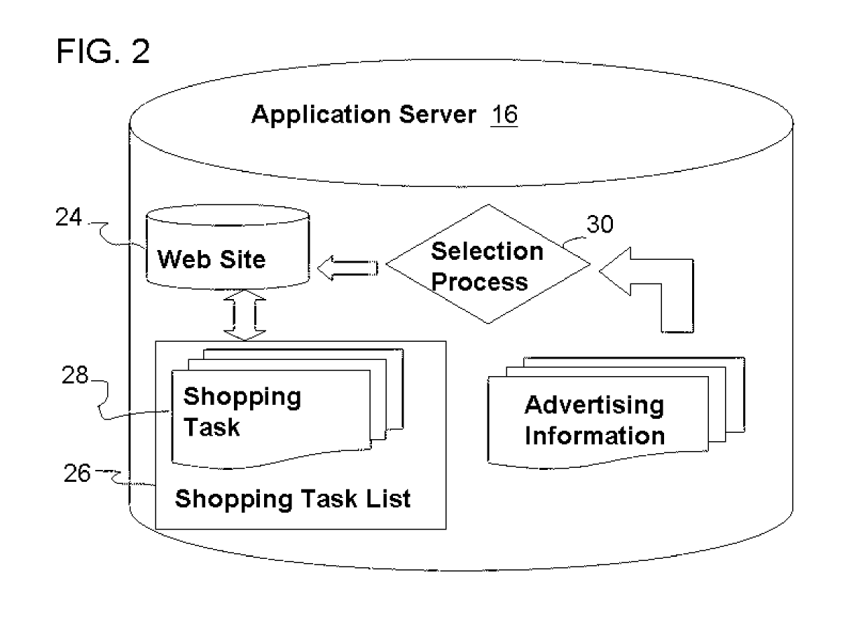

FIG. 1 is a simplified block diagram of the environment in which one exemplary application server of the present invention will be operating. Application server 16 of FIG. 1 may comprise a plurality of subsystems, which are illustrated in FIG. 2 in a simplified block diagram.

In a non-limiting example, website 24 in FIG. 2 provides a shopping task management service which allows consumers to create, read, update, delete and share shopping task information. Shopping task could be created by consumers from scratch on the web. Shopping task could also be created by software automatically depending on certain user actions. Consumers should also be able to submit new shopping task via SMS, MMS, instant message, chat, email or others message technologies.

Typically, consumers use personal computers to access website 24 through internet. For example, Consumer 10 could use computer 20 of FIG. 1 to access website 24 on internet 18 of FIG. 1. For some consumers, they could visit website 24 and use said service with wireless devices if their wireless devices are capable of accessing website 24.

A typical shopping task contains some or more of the following attributes: Item (product or service to be acquired), preferred brand(s), category, quantity, preferred provider(s), Due, for who, status, comment, created by (whom), requested by (whom), shopping location and etc.

As an example, a typical shopping task may have the following attributes and contents:

ID: 1

Item: sneaker

Preferred Brand: BrandABC

Category: apparel

Quantity: one pair

Due: 8/28

For Who: Jackie

Status: planning

Comment: Jackie like it to be silver in color

Created by: Tom

Buyer: Jane

Shopping location: YMart at Lakewood

It is important to note that there could be other attributes to further describe a shopping task; there could be other possible names for the same attribute. It is also possible that fewer attributes than mentioned above might be needed to provide a satisfactory shopping task management service. There might be other names for the same service achieving the similar goals, for example: to buy list, shopping list, and etc. It should be understood that consumers are not required to fill in all attribute contents in order to use said service. Said application server could fill in some of the blank attribute contents based on task history and other information available. For example, attribute of “created by” could be auto filled in by said website if user ID is known. It is the intention of this invention to cover all such modifications, alterations and adaptations without departing from the scope and spirit of the present invention.

Consumers using said service can share the same shopping task list among other consumers belonging to the same group. Group Members can create, read, update and manage other attributes of a shopping task list. Depending on their usage right, which is set by the account manager who could be one of the consumers, group members can change some or all of the attributes of a shopping task created by other group members.

There are different ways group members can log into a shopping task list account. For example, group members can use the same account ID, but use different user IDs and passwords to identify each member when login. In another example, group members can use the same account ID but use different passwords to identify themselves when login.

Said service provides key features to facilitate the sharing of a shopping task list. It is capable of keeping track of changes made to the shopping task list, including information of who made what changes, who created which task and etc. Said service is also capable of presenting such information for consumers to review. Consumers should be able to fold different tasks into one task if they are deemed to be the same task but submitted by different persons or by the same person at different times. In yet another example, each task is assigned with a unique task ID; therefore each task can be referred to with a unique ID to avoid any ambiguity among group members. For each shared shopping task, creator and actual buyer could be different; therefore there may be a need for a designated buyer attribute for each task.

It is obvious that said application server is capable of providing the same service to users who do not share their shopping task lists with anyone else.

Said service could provide fewer or more of data management services common to a typical database such as forms to add, delete or revise shopping tasks; filters to select a subset of tasks, queries to present selected tasks in different sorting orders; reports to present different sets of shopping tasks selected from the same data source for different usage cases. Consumers should be able to search for certain tasks by keywords or by task attributes. Said Service may also provide the feature for reoccurring tasks, such as buying air conditioning filters on regular basis. Consumers should be able to copy or save a copy of a subset or complete set of the shopping task list.

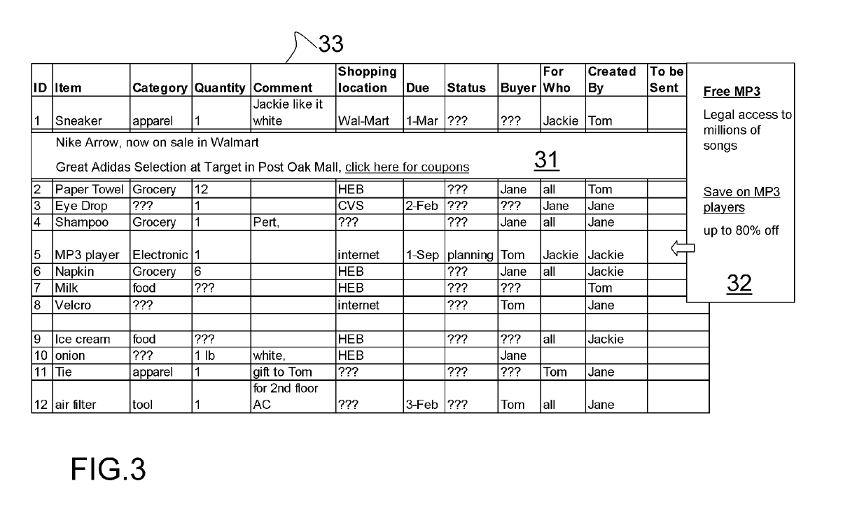

FIG. 3 depicts a non-limiting example where a shopping task list is taking consumer inputs. When tasks are added to the list, some fields are filled with “???” indicating consumers have yet to decide on certain requirements. There are some columns like comment 33 in FIG. 3 on the task list are not likely to be used in sorting, and are optional and in variable length. It is possible to present the contents in cells of these columns on rows immediately below the corresponding task, such as area 31 of FIG. 3. So that column for comment 33 could be taken out from the table, and saves more space for advertising area 32 of FIG. 3. It is also important to note that shopping task list could also be presented in a list of entries or paragraphs without graphical elements of a table.

In addition to above mentioned capabilities, present invention calls for other unique features that can improve consumer shopping task management experience.

While consumers are allowed create shopping tasks in random order, said service enables consumers to sort shopping task list by task attributes. For example, shopping tasks could be sorted by designated buyers, so that they can select and review only those shopping tasks assigned to them. In another example, shopping tasks could be sorted by item category so that tasks of buying items belong to the same or similar categories are grouped together. This feature is helpful to spot redundant entries for the same shopping item. This feature is especially helpful in retail shopping environment. When following the sequence of sorted shopping task list, consumers are reminded to buy all related items in the same or adjacent aisles where retailers usually group items together. This prevents repeat visits of the same area or same store when consumers go shopping following a randomly ordered shopping task list inadvertently.

In another example, rather than sorting in alphanumerical order of item category, said service could provide specialized sorting orders which shopping tasks are sorted by item category following orders in which certain retailers arrange their offerings in retail locations. In this case, when following the sequence of shopping tasks sorted in this manner, consumers can navigating their paths inside a shop more efficiently.

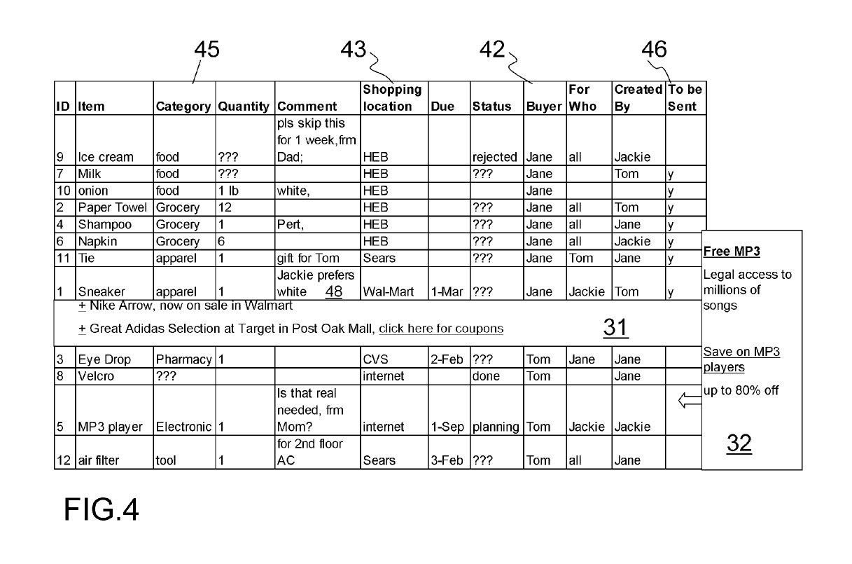

To further enhance the shopping experience of consumers, said service could provide multiple criteria sorting capability. As a non-limiting example depicted in FIG. 4, original shopping task list from FIG. 3 is now revised by consumers, some fields are being filled in, and this list is now 1^{st} sorted by designated buyer 42, then sorted by shopping locations 43, and finally sorted by item category 45. With the newly formatted list, consumer can plan the shopping trip more efficiently by finding the most optimized path or the shortest path of visiting all locations mentioned in the list. To simplify usage of complicated sorts, such sort settings could be saved or provided by said service for consumers to select from.

Said service may also provide other needed information to facilitate the shopping task. For example, when shopping task of buying a pair of sneakers for the family's 5 year old daughter is created, information about the foot size of the daughter can be searched by the said service from user account information. If found, such information may be presented along with the shopping task. Such information could also be sent to other electronic devices along with the shopping task when the task is being sent.

While there are other types of consumer groups sharing shopping task lists in different ways, some of our following non-limiting examples focus on usage cases in which a family shares a shopping task list among its family members. Family members mentioned in below description are consumers as mentioned in foregoing descriptions.

Family member Tom creates an account on website 24 and shares shopping task list 26 of FIG. 2 with other family members. As an option, when Tom is creating the task account, he can also create user accounts for his family members, provide relationship, age, sex, and other information of each member to said website.

During the intervening time between shopping activities, family members can add shopping tasks by logging into the task account using their own IDs and passwords. They can also change attributes of those shopping tasks already created by others, for example parents can approve or disapprove certain items on the list and make comments on others. Family members can do search and sorting operations on the list and save certain operation results.

At the time the real shopping is about to take place, consumers can print out a subset or complete set of a selected shopping task list on paper, for example using printer 14 on FIG. 1. When actually doing the shopping in stores, family members can review the printed list and follow the order and instruction come with the list.

In another example, consumers can request application server 16 to send the same set of selected shopping tasks to other electronic devices. For instance, shopping task list 26 could be sent to wireless device 12 of FIG. 1. After receiving shopping task list on wireless device 12, family member can then review the received information during the actual shopping in similar ways as they use a printed list.

Shopping tasks to be sent could be generated dynamically as consumers manage the task list. Previously saved task sets generated by using sorting, querying, reporting or other database operations could also be sent.

Consumers could make requests of sending selected shopping tasks when they are visiting website 24 with computers or other electronic devices such as cell phones. Consumers could also send such requests from cell phone or other wireless devices using message technologies such as SMS, MMS, email, instant message, chat and others that are available on networks. For example, when consumer is at a shopping mall and away from home computer, a request in SMS format generated from a wireless device by the consumer could be sent to a special account number on a wireless network, wireless network will forward such request to application server 16. Upon receiving such request, said service could send selected shopping task list to designated wireless devices as instructed in the requesting message or account settings.

Application server can also send shopping task list information at predetermined timings to designate electronic devices according to consumer account settings. As an option, said service could allow one group member to send a selected shopping task list to an electronic device carrying by another group member. A typical usage of such feature could be a wife could send a shopping list from home to her husband who is doing the shopping at a grocery store.

It is important to note that one of the major purposes of having shopping task lists sent to other electronic devices or printed on papers is to guide consumers during actual shopping, while the website is mainly use for allowing consumers to manage and share the shopping task lists. Therefore formats and contents of the same list on different media, such as website and cell phones, should be different. In some instances, due the limited display and storage space available on wireless devices, not all shopping task attributes available on website are sent or displayed on these devices. For example, when a task list is sent to a cell phone, designated buyer field and create by field are likely not needed and therefore not sent. Same considerations could be taken when said application server prints the shopping task list on papers.

In general, the order of a shopping task list, revised by consumers typically before sending to other electronic devices, is designed to control the sequence in which consumers carry out the shopping tasks. As one of the key features, when said service sends selected shopping task list to other electronic devices such as printers or wireless devices, the logic order of the sourcing list is preserved. This feature helps to prevent repeat visits of the same store, or same area within a store, when a disordered shopping task list stored on the receiving electronic device or on printed paper is followed by consumers unwittingly during shopping.

Such feature is achieved when said application server composes selected shopping task list to be sent in such manner that the normal reading order or normal presenting order of the received shopping task list presented by electronic devices or printed paper is in the same order as the sourcing shopping task list on application server 16. If consumers forget to sort the shopping task list in orders, said service could remind consumers for such action or do the sort at default setting before sending the list.

Except for Arabic or Hebrew, in most languages, normal reading order of a typical electronic device display or paper is from left to right and from up to down. Task on the higher position is considered as the one in the front of a sequence. If two tasks are at the same height on a display area, the one on the left side is considered in the front of a sequence. Take SMS message as an example, when application server composes the message, task entries are placed in order from left to right, until the line is filled, following tasks are placed at the next lower line and start from left again. In this way, task order of a list is implicated by positioning, i.e. the normal reading order, of each task within the message. Task entries can be separated from each other by, and not limited to, space, line breaks, characters, wordings, symbols or graphic elements such as lines, colors, fonts, location and other means.

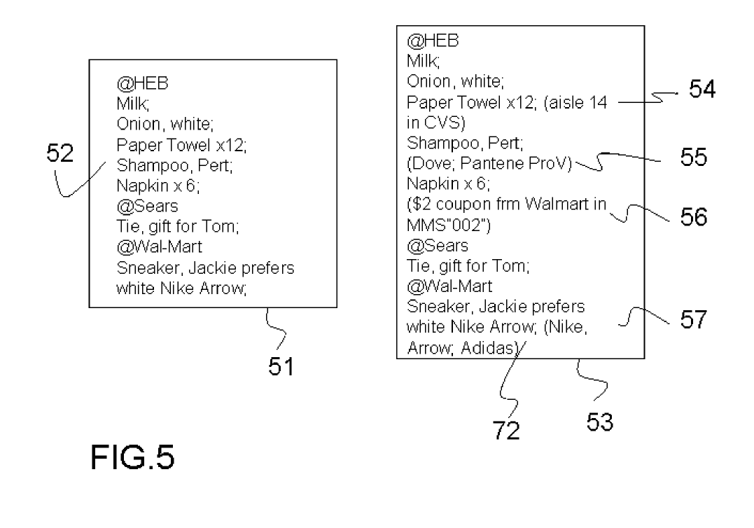

FIG. 5 is a non-limiting example of a SMS messages generated from task list on FIG. 4. Task list 52 of FIG. 5 in SMS message 51 contains tasks selected by field 46 of FIG. 4. Notice the sequence of task list 52 is the same as that on the list in FIG. 4.

In situations where multiple messages are needed to transmit all the selected shopping tasks to other electronic devices, said service will assign keywords to certain message attributes, or send these messages in sequence, so that information about the logical order of these messages are conveyed. The order in which consumers open these messages determines the reading order of these messages. For example, selected shopping tasks 1 through 5 are to be sent in SMS format at the request of a consumer. If each SMS message can only contain 2 task items, said service will copy tasks 1 through 2 in original sequence into SMS message #1 which begins with text “buylistA, 1/3”, copy tasks 3 through 4 in original sequence into SMS message #2 which begins with text “buylistA, 2/3”, copy task 5 into SMS message #3 which begins with text “buylistA, 3/3”. In general, said service will also send these messages in sequence: message #1 first, message #2 second and message #3 at last. At the receiving end, consumer can go shopping by following task listed inside these messages. Consumer could open message 1/3 first, 2/3 next and 3/3 the last. Therefore the original intended sequence of the shopping task list is followed.

As another example, shopping tasks could be assigned to different messages so that one message only contains shopping tasks assigned to one shopping location. For instance, even if one MMS message could contain more than 20 shopping tasks. When a total of 9 shopping tasks are to be sent, the service could opt to assign 4 tasks with the same shopping location in one MMS message, and put the rest 5 tasks pointing to another shopping location in anther MMS message. Since all items within a message belong to the same shopping location, shopping location information needs to be mentioned once in each message, not for each task. This feature allows consumers to read only pertinent messages when in a certain shopping location. This also makes it easy to present advertising information relevant to the same shopping location if shopping tasks and their relevant advertising information are not taking up all available space in the same message.

In case the shopping task list is presented by the receiving electronic device automatically or interactively, for example playing an animation clip according to user inputs, the timing order in which tasks are presented, i.e. normal presentation order, implicates the sequence of the list.

For those consumers who can access website 24 with their wireless devices directly at different retail locations, they could still request sending or receiving shopping task messages to wireless devices. Sometimes, it is more convenient and simpler to read static messages than to search information interactively when using mobile electronic devices come with small display area.

After the shopping is done, family members can update shopping task status, delete old tasks, and add new tasks for the next shopping cycle.

Selecting Advertising Information

Information generated by consumers when using said service can be used by application server 16 to extract shopping related information such as item, category, brand name, due date, who created the item, item is for who and etc. Application server 16 can also collect information on usage history of said service, such as when and how frequent the shopping list is printed; when, how, what and to whom the shopping list messages are sent to.

There are other possible internet based services that could provide rich shopping related information, for example:
Decision process of deciding which university or school is the best suit for kids
Wedding management
Decision process of big ticket item acquirement
Home improvement management
Vacation planning
House buying
House selling
New home decoration, internal design

Application server 16 can provide any one or more of the above mentioned services, including said shopping task management service, and those beyond the above list. All these services help to generate needed information, including shopping related information, useful in the process of selecting and presenting advertising information to targeted consumers, shopping lists and shopping tasks.

To entice consumers to use those services that provide rich shopping related information, application server 16 could also provide other services useful to consumers even if these services do not contribute or contribute very little shopping related information. For example, message board where members could leave messages to others, calendar where group activities are recorded. Application server 16 could also provide targeted advices and suggestions to consumers based on the information obtained from these services.

With methods and systems described above, consumers can enjoy the benefits of mentioned services and at the same time are able provide their own shopping related information to one known trusted entity effortlessly. The need of taking extra effort to upload shopping related information to different unknown recipients on the web is one of the key reasons preventing consumers from sharing their shopping related information with outside world.

Shopping related information and other information collected by application server 16 can be shared with a plurality of interested product or service vendors. In one exemplary example, application server 16 can create at least one internal user ID for every consumer. Said internal user ID has one to one relationship corresponding to an actual consumer. When application server 16 provides shopping related information or other available information to interested vendors, said internal user ID is provided and the real consumer ID and other private information consumers wish to protect are withheld. Such method allows vendors to keep track of consumer information and activities without actually knowing the real identity of consumers. Therefore consumer privacy is protected.

Using information from application server 16, potential product or service venders could decide when, what, how and to whom their advertising information should be directed. Such decision could be made based on a single piece of information or based on statistical data derived from a large amount of data coming from one or more accounts. Such decision could be made in real time, or made before hand by calculation based on historical data.

Product or service vendors could also supply advertising information without receiving any information on consumers from application server 16, and allow application server 16 to decide how to select and present advertising information to targeted consumers.

It is possible for website 24 to allow consumers to mark certain shopping tasks which consumers would like receive relevant advertising information. Information on these shopping tasks could be used by application server 16 to solicit advertising information from potential product or service vendors at higher priority.

Advertising information could also be collected by application server 16 from open sources like the internet. Application server 16 could also generate advertising information to promote its own products and services.

Application server 16 searches collected advertising information, and selects those pieces which are relevant to one or more shopping tasks, or relevant to items on other services, locations, accounts, consumers and other entities of information. Application server 16 also determines which piece or pieces of advertising information are more relevant than the others and therefore have higher priorities. Application server 16 uses certain algorithms to determine which consumers are more receptive to certain piece or pieces of advertising information.

Above mentioned decision making processes, including selection process 30 as depicted in FIG. 2, would consider a number of factors. They could include and are not limited to: shopping related information such as certain attributes of a shopping task, consumer usage history on website 24, consumer setting on the account, advertising information sponsor requirements, timing of the process, season of the year, consumer demography and other available information collected by application server 16.

For example, shopping task attributes which are considered to be shopping related information, along with other information are taken into consideration in deciding whether a piece of advertising information is relevant. Some of them as list here:
Name of product or service: sneaker
Preferred Brand: BrandABC
Item Category: apparel
Preferred Retailer: SellerABC
Time Needed: 8/28
Shopping Status: planning

If, for a shopping task, contents of one or more of above attributes, or other information not listed are found to have a matching or closely related keyword or keywords in a certain piece of advertising information. This piece of advertising information is considered relevant to the corresponding shopping task. Each shopping task, in potential, could have more than one piece of relevant advertising information.

Other information could also be used by application server 16 in its decision making processes. For example, in the near future, when location information of wireless devices becomes readily available, said application server could also utilize such information in its process of determining the relevancy of advertising information if consumers are willing to share such information. There are other methods application server 16 could employ in above mentioned decision making processes.

Shopping task status could also play a role in deciding whether relevant advertising information should be presented. For instance, when a shopping task has been marked as done, there might be no need to search for any relevant advertising information at all. Even if there is known relevant information readily available, said application server could decide not to present relevant advertising information for such task so to leave more room for other advertising information.

It is apparent that advertising information could be found to have certain associations with a shopping task, a consumer, an account, a location or many other entities of information collected from services such as shopping task management. While following examples focus on the case of association between relevant advertising information and corresponding shopping tasks, other types of association could be used by vendors to promote their products or services in similar manners. It is the intention of this invention to cover all such variations and adaptations without departing from the scope and spirit of the present invention.

Presenting Advertising Information

After selecting and ranking piece or pieces of relevant advertising information for a certain shopping task, application server 16 can present those pieces of advertising information along with other information on website 24.

Advertising information needs to be composed and formatted in different ways depending on the media and electronic device on which it is to be presented. Different versions of the same adverting information suitable for different applications could be designed before hand or created dynamically be applications server. On a typical website, each piece of advertising information is often represented by a brief message containing more or fewer of, but not limited to, title, short description lines, hyperlinks, icons, images and other elements. Consumers can click on those hyperlinks to get complete advertising information about a product or service from other web pages on website 24 or from other websites designated by hyperlinks.

It is important to know that depending on consumer selections, amount of information in these brief messages could be adjusted by application server at the requests of consumer or automatically. If the content of advertising information is compact enough, brief message could contain all content of the advertising information. On the other hand, if display area reserved for brief message is large enough, said application server is capable of deciding that brief message is not needed, and proceeds to display full content of advertising information in the reserved area.

To represent the associations between a shopping task and advertising information, said brief messages are usually posted in proximity locations to their matching shopping tasks. There are a number of alternatives to achieve similar result, including color scheme, graphic illustration, interactive presentation and others.

For example, graphical elements such as lines or arrows could be drawn connecting brief messages to their corresponding shopping task item, as depicted by area 32 in FIG. 3 and FIG. 4. In another option, brief messages are placed, on web page, below their corresponding shopping task item and above the next shopping task in the sequence, as depicted by area 31 in FIG. 3 and FIG. 4. In yet another option, brief messages associated with a focused shopping task can take up all of the available advertising information space, usually on the left margin or bottom margin of a web page, as focus changes to other shopping tasks, advertising information and brief messages change accordingly. Popup windows could also be used to present advertising information when cursor is moved into certain area. For simplicity in illustration, only part of the displayed advertising information the real situation is illustrated in FIG. 3 and FIG. 4.

It should be apparent that advertising information could be presented on more or fewer areas mentioned above. And it is also possible not all the advertising spaces are taken simultaneously as any time.

It should be understood that above mentioned processes of collecting, selecting and presenting advertising information may take place independently and dynamically. Each process can be activated on their own schedules or in coordinated manners. Each time the same process might generate different data for down stream process to consume. Therefore, it is possible for the same shopping task, depending on the timing of the webpage is generated, or the user ID, or other information available to application server, consumers may be presented with different sets of relevant advertising information, or same set of advertising information in different priority sequences.

For example, a shopping task submitted by Ben, a 15-year-old boy in the family, is to buy a computer game some time next month. When Ben's father logs in and reviews the shopping task list, the top advertising message for this shopping task could be an educational software title which helps students to improve their SAT scores. In the other occasion, when Ben himself logs in, the top corresponding advertising message might be a different one, for example an action game title.

Depending on the usage right, family members can change the account settings which control how and what advertising information could be placed on the website. Consumers could also disallow any advertising message specifically targeting children to be displayed when viewer of a webpage is identified by account information record as a child.

User Reactions to Advertising Information, User Comments and User Collected Information

Consumers can do research for shopping task items themselves. URI and other information on computers or internet collected by consumers, along with consumer comments on these data, can be recorded by said service and shared among group members. Said service maybe able to provide a storage function which stores consumer visited web pages in form of cached pages. As an option, association between consumer collected information and a relevant shopping task may be presented the similar way advertising information is presented along with its associated shopping task item. Consumer collected information could be preserved and made available until the corresponding shopping task is deleted or is marked as done.

As another key feature of said service, consumers are able to comment to presented advertising information that is of particularly interesting. Consumer comments and planning about what to do with certain advertising information could be recorded along with the advertising information or recorded with the task that the advertising information is targeting.

FIG. 5 and FIG. 4 present a non-limiting example of recording user reaction to a piece of adverting information. In this particular embodiment, user reaction is recorded and the information is embedded into user comment by the shopping task management service.

Notice the area 48 of FIG. 4 did not have reference to Adidas sneakers in the comment field for the task of buying a pair of sneakers for Jackie when the task was created by Tom. When Jackie was reviewing the shopping list, she was presented a piece of targeted advertising information for that shopping task as showed in area 31 on FIG. 4. She responded to the advertisement by clicking the plus sign at the beginning of the advertisement message. This shopping task management service responded by displaying a popup window where Jackie put in her reaction, in this case, she decided to go with Nike. Her reaction was then recorded by said service, and in this case, the information was embedded into the task's comment. By doing so, Jackie's reaction is associated with the shopping task since the reaction information is now on the shopping task's comment. The reaction is also associated with the advertising information because the comment contains the wording of “Nike Arrow”. The visible result of the said service action is shown on task entry 72 on FIG. 5.

With more sophisticated approach, Jackie's reaction could also be stored as a database record associated with the targeted shopping task as well as the targeting advertising information. Such technique makes collecting statistical data on effectiveness of advertisement possible.

Said service should be able to keep records of advertising information denoted by consumers and make them available for access until they are deactivated by customers. The indication of interests on certain adverting information and related consumer activities are also valuable information for advertising information sponsors and application server 16 to collect and process.

Presenting Shopping Related Information and Advertising Information to Other Devices or Media

Said application server is capable of allowing consumers to request a subset or complete set of advertising information and consumer collected information be printed or sent to other electronic devices. Such information could be sent either along with shopping task lists or be sent separately. Wherever selected advertising information is sent, the corresponding consumer comments and reaction information about the advertising information could also be sent as long with the advertising information.

Consumers could make such requests to application server 16 via internet from PC or from other electronic devices including wireless devices. Consumers could also make such requests from wireless devices using SMS, MMS, email, instant message, chat or other message technologies available on networks. As an option, location of the wireless device at time of such request is raised could be used in selecting the relevant adverting information.

While methods and systems to handle advertising information are presented in the following description, it is apparent that similar methods and systems are applicable to consumer collected information and consumer reaction information. Consumer collected information, consumer reaction information and advertising information could be selected and presented to other devices in separately or together in similar ways described in below section. It is the intention of this application to cover such cases.

Application server can dynamically compose and format the selected advertising information for different electronic devices, or it can select the suitable version of such advertising information designed before hand. Assembling entries of advertising information into transmittable formats is usually done dynamically before a transmission. It should be apparent that advertising information could be sent in any compatible format that receiving electronic devices can process, such as SMS, MMS, email, instant message, chat, graphic file, audio/video/animation file, webpage, data file or others.

Due to limited display space on wireless devices, PDAs and printing paper, some contents for advertising information may not be sent or displayed. For example, there is no need to include hyperlinks with URL on the printed version or SMS version of advertising information. Since there is limited space on paper or short message format, only a couple of key words such brand name and model number could be presented with its matching shopping task, other descriptive wordings available on web page version of the advertising information are usually stripped.

Application server 16 can send embedded advertising information along with the targeted shopping task whenever the encompassing shopping task list is sent to other devices at the request of consumers. For example, when a consumer requests shopping task list 26 containing shopping task 28 of FIG. 2 to be sent to wireless device 12 in SMS format. If application server 16 finds a matching piece or pieces of advertising information for shopping task 28, the advertising information will be formatted and inserted into the message containing shopping task list 26 and sent to wireless device 12. Similar process applies to printing a shopping task list, selected advertising information are printed along with the task list.

As one of the key features of this invention, when sent along with corresponding shopping tasks to other electronic devices such printers or wireless devices, relevant advertising information is embedded in such way that it can be presented to consumers at moments right before or right after the corresponding shopping task is read by consumers, or presented to consumers. This feature is achieved by strategically placing part of, complete body of, or a brief message of the selected advertising information along with the corresponding shopping task and before the next shopping task in terms of normal reading order or presentation order.

For instance, relevant advertising messages are placed in between two tasks of a sorted list, right after the targeted shopping task and before the next task. If the relevant advertising information of a shopping task is taking up too much space, application server could place a reference or brief message or hyperlink right after the targeting shopping task explaining that that more detail information is available in other locations. For example, if a shopping task has a relevant advertising message including a large size coupon with barcode image, application server could insert a brief message right after the corresponding shopping task but before the next shopping task on the list. Said message could be “$2 coupon from Walmart on page 3”, in case of a printed shopping task list. In case of SMS format, said message could be “($2 coupon form Walmart in MMS“002”)”, as depicted by message 56 of FIG. 5.

Tasks and advertising information entries could be separated by, and not limited to, space, line breaks, characters, wordings, symbols or graphic elements such as lines. Advertising information and tasks could be set apart by wordings, symbols, characters, graphic elements, colors, fonts, positioning and other means.

Same method is applicable to those shopping tasks presented automatically or interactively in timing sequence by electronic devices, such as playing video clips. Relevant advertising information could be presented the moment after the corresponding shopping task is presented and before the presentation of the next shopping task starts.

For adverting information associated with information other than a particular shopping task, it could be presented in other appropriated manners. For example, Target could place a video clip to promote its image in a MMS message which contains shopping tasks to be done in Target. This clip is played whenever the message is opened by consumers. In another embodiment, such advertising information is grouped together and printed in separate pages after those pages containing shopping task information and corresponding advertising information are printed.

Providing tight coupling, in term of normal reading order, between the advertising information and corresponding shopping task improves the effectiveness of advertisement due the fact that consumers are reminded of the promotions at the time and at the sequence they review the corresponding shopping tasks. For applications such mobile electronic devices or printed shopping task lists, such tight coupling also saves precious displaying space by not having to display attributes of adverting information that are already clearly described by the shopping task. For example, shopping task of buying a pair of sneakers for consumer B, corresponding advertising message could be as simple as “Nike Arrow”, and there is no need to display keyword “sneaker” in the body of advertising message.

SMS message 53 of FIG. 5 is an example of a message sent to consumers when advertising information is embedded with the shopping task list. In this non-limiting example, advertising information is placed within parenthesis so shopping task information and advertising information is distinguishable by reader. Advertising information 54, 55, 56 and 57 of FIG. 5 are placed in strategy locations where they are being review by consumers immediately after consumers review the corresponding task on the list. Different pieces of advertising information for the same shopping task are separated by semicolon in this example. The resulting task list in message 53 still preserves the same order as the original task list 52 of FIG. 5. For simplicity in illustration, not all advertising information displayed in message 53 is shown on FIG. 4.

Above example assumes receiving electronic device is capable of handing SMS message longer than 160 characters, usually by merging together two or more specially formatted messages sent by sender. As an alternative, message 53 could be broken into and sent in three individual messages by application server. The 1^{st} message contains tasks and advertising information all for HEB, the second message contains tasks and advertising information all for Sears, the 3^{rd} message contains tasks and advertising information all for Wal-Mart.

When grouping shopping tasks by designated shopping location, shopping location information could be presented once for every group, therefore saving precious displaying area that would have been taken if the same location information has to be presented for every shopping task. This is especially efficient for displaying information on cell phones, PDAs or printed paper.

Application server 16 could also send advertising information in separate messages containing no shopping task information to designated electronic devices including cell phones or other wireless devices as permitted by consumers, or at the request of consumers. If shopping task information had been sent to the same electronic device, the same format could be used in sending advertising information.

In one embodiment of presenting association between relevant advertising information and corresponding shopping task, advertising information sent in separate messages to other electronic devices could contains an unique task ID referring to the targeted shopping task sent before or after such advertising information is sent. Unique task ID could also be used in the message in which consumer request for advertising information for a particular shopping task.

Depending on the usage agreement, consumers could change the account settings which control how, what, how much, and when advertising information can be sent to certain electronic devices. In one example, consumer 10 can specify that no advertising information could be sent to a wireless device 12 between 10:00 pm to 8:00 am unless requested by consumers. In another example, consumer 10 can specify only SMS message and no MMS could be sent to wireless device 12.

Due to the fact that there are costs associated with providing the said shopping task management service and sending messages over the internet or wireless network, said service could call for consumers to agree to receive advertising information and with or without other concessions in exchange for the right of using such service and sending pertinent messages over the internet and wireless network. For example, a usage agreement would outline as: there shall be no more than two advertising information messages to be sent to a wireless device for every message containing shopping task information is sent to the same wireless device.

It should be apparent that for those consumers capable of accessing shopping task management service from their wireless devices, they could also opt to receive selected advertising information messages on their wireless devices for convenience and simplicity.

### SUMMARY

As we can see from above description, when consumers input information to be managed by the shopping task management service, the same information enables product or service providers to tailor and target their advertising information to these consumers. Consumers avoid the need of inputting information repeatedly only for the purpose of receiving advertising information.

Even thought it is not been elaborated, above described systems and methods of shopping task management service and presented advertising information also provide consumers a better experience in doing shopping on the internet.

While embodiments of the present invention have been described in this application, it should be apparent, however, that various modifications, alterations and adaptations to above mentioned embodiments and other embodiments may be apparent to persons skilled in the art. It is therefore this application and the provisional application are intended to cover all such modifications, alterations and adaptations without departing from the scope and spirit of the present invention.

What is claimed is:

1. A method of providing internet based shopping task management service for users to manage shopping task information, the method comprising: providing means allowing users to create and maintain shopping task list accounts; providing means allowing users to create, read and update shopping tasks on accounts; providing means allowing sharing of the same shopping task list account among a plurality of users with user accounts.

2. The method of claim 1, wherein the method further comprising of providing means for one or some or all shopping tasks on the list to be associated with one or more designated buyers who would do the buying.

3. A method of providing internet based shopping task management service for users to manage shopping task information, the method comprising: providing means allowing users to create and maintain shopping task list accounts; providing means allowing users to create, read and update shopping tasks on accounts; providing means allowing sharing of the same shopping task list account among a plurality of users with user accounts, wherein providing means for users of a shopping list account to designate none or one or some or all entries of shopping task they created to be partially or completely not visible or not accessible to one or some or all other users who share the same account.

4. A method of providing internet based shopping task management service for users to manage shopping task information, the method comprising: providing means allowing users to create and maintain shopping task list accounts; providing means allowing users to create, read and update shopping tasks in accounts; providing means to sort those shopping task items, which are assigned to the same physical shopping location, using a predefined sorting order which is designed specifically according to the physical arrangement of merchants or services in said physical location, so that consumers can take the most optimal route during shopping by following the order of the processed shopping task list.

5. A method of providing internet based shopping task management service for users to manage shopping task information, the method comprising: providing means allowing users to create and maintain shopping task list accounts; providing means allowing users to create, read and update shopping tasks accounts; providing means allowing an option to group shopping task items by designated physical shopping locations and present the common physical shopping location information once for each group.

6. The method of claim 5, the method further comprises means of selecting adverting information targeting shopping tasks grouped by shopping locations; presenting selected advertising information wherein when groups of shopping tasks are presented in any logical order in terms of time, space or both, all advertising information, which is selected to be presented for a specific group of shopping tasks, is presented along with the targeted group of shopping tasks before the next group of shopping tasks is presented.

7. A method of providing internet based shopping task management for users to manage shopping task information, the method comprising: providing means allowing users to create and maintain shopping task list accounts; providing means allowing users to create, read and update shopping tasks on accounts; providing means to transmit pre-selected shopping tasks to pre-selected electronic devices at predetermined timings.

8. The method of claim 7, wherein when transmitting a shopping tasks, the task can be transmitted along with other pre-selected relevant information associated with the task, including any or any combination of, and is not limited to, targeted advertising information, user reaction, user collected information and user comments.

9. A method of presenting advertising information to a shopping task management web page where users manage shopping task information, the method comprising: storing shopping task information from one or more users; storing advertising information in one or more databases; selecting advertising information targeting one or more shopping tasks; presenting selected advertising information, wherein when shopping tasks are presented in any logical order in terms of time, space or both, all advertising information, which are selected to be presented for a shopping task, is presented along with the targeted shopping task before the next shopping tasks is presented.

10. The method of claim 9, wherein the method further comprises providing means for consumers to store their reactions to presented advertising information on the said service.

11. The method of claim 9, wherein selected advertising information is being presented by means including any or any combination of, and are not limited to, displaying, highlighting, flashing, moving, color changing and sign designating the content of selecting advertising information.

12. A method of presenting advertising information to printing material generated by a shopping task management service where users manage shopping task information, the method comprising: storing shopping task information from one or more users; storing advertising information in one or more databases; selecting advertising information targeting one or more shopping tasks; printing selected advertising information, wherein when shopping tasks are printed in any logical order, all advertising information which is selected to be printed for a specific shopping tasks, is printed along with the targeted shopping task before the next shopping tasks is printed.

13. The method of claim 12, wherein when printing a shopping task, the task can be printed along with other pre-selected relevant information associated with the task, including any or any combination of, and is not limited to, targeted advertising information, user reaction, user collected information and user comments.

14. A method of presenting advertising information to a shopping task management web page where users manage shopping task information, the method comprising: storing shopping task information from one or more users; storing advertising information in one or more databases; selecting advertising information targeting a shopping task; presenting selected advertising information, wherein when a shopping task gains focus on a software interface, all advertising information which is selected to be presented for this shopping task, is presented differently from other advertising information not targeting this shopping task.

15. The method of claim 14, wherein a shopping task gains focus on a software interface includes states that this shopping task is either being highlighted, selected, created, or edited.

16. The method of claim 14, wherein selected advertising information is being presented differently includes means of any or any combination of, but are not limited to, displaying, highlighting, flashing, moving, color changing and sign designating the content of selecting advertising information while no same action applies to other advertising information which is not targeting the shopping task currently gains focus.

17. The method of claim 14, wherein the method further comprising providing means for consumers to store their reactions to presented advertising information on the said service.

18. A method of managing reactions to advertising information presented to a shopping task management web page, the method comprising: storing shopping task information from one or more users; storing advertising information in one or more databases; selecting advertising information; presenting selected advertising information; storing user reactions to the presented advertising information in one or more databases, step comprises referencing at least one piece of advertising information from the stored reaction information.

19. The method of claim 18, wherein said reaction information contains information referencing at least one targeted shopping task.

20. The method of claim 18, wherein when said shopping task list is shared with more than one user, said reactions information contains information referencing to the user who created the current piece of reaction information.

21. The method of claim 18, wherein when said reaction to advertising information indicates an intention of buying one or more items which are not on the current shopping task list, one or more new tasks are added to the same shopping task list.

22. The method of claim 18, wherein when a piece of advertising information is associated with at least one piece of reaction information, it is preserved until all associated reaction information is deleted.

23. The method of claim 18, wherein the method further comprises storing the statistic data on reaction information.

24. The method of claim 18, the method further comprises presenting users reactions along with shopping task, wherein when shopping tasks are presented in any logical order in terms of time, space or both, reaction information which is associated with a shopping task and is also selected to be presented, is presented along with the associated shopping task before the next shopping task is presented.

25. A method of managing webpage Uniform Resource Identifiers (URIs) or computer file URIs associated with a shopping task item on a shopping task management service, the method comprising: storing shopping task information from one or more users; identifying URI information user wants to store; identifying the shopping task to be associated with the URI information; storing the URI information in one or more databases, steps comprising: URI is associated with at least one shopping task; each shopping task could be associated with none or one or more URIs.

26. The method of claim 25, wherein the method further comprises obtaining and storing user comments or reactions to the information referenced by the URI, wherein each comment or reaction is associated with at least one URI entry.

27. The method of claim 25, wherein when there is no matching shopping task on the current shopping task list to be associated with a new URI, a corresponding shopping task is added to the shopping task list.

28. The method of claim 25, wherein the method further comprises storing a snapshot of the information referenced by the URI.

29. A method of managing relevant information for a shopping task item on a shopping task management service, the method comprising: storing shopping task information from users; identifying the relevant information user wants to store; identifying the shopping task to be associated with the relevant information; storing relevant information, wherein relevant information is associated with at least one shopping task.

30. The method of claim 29, wherein the relevant information includes web page contents.

31. The method of claim 29, wherein the relevant information includes coupon documents.

32. The method of claim 29, wherein the method further comprises obtaining and storing user comments or reactions to the relevant information, wherein each comment or reaction is associated with at least one piece of relevant information.

33. A method of searching pertinent electronic information for one or more shopping tasks on a shopping task management service, the method comprising: storing shopping task information from users; creating search queries based at least in part on shopping task information, wherein each search query is associated with at least one shopping task; presenting search result to user; storing none or one or more the search result entries selected by user, wherein each stored search result entry is associated with at least one search query.

34. The method of claim 33, wherein the method further comprises obtaining and storing user reactions or comments to search result entries, wherein each comment or reaction is associated with at least one search result entry.

35. The method of claim 33, wherein the method further comprises providing options which users can select which search engine or engines to be used in the search.

36. The method of claim 33, wherein the method further comprises providing options with which user can further refine the search query.

37. The method of claim 33, wherein information is searched on the internet.

38. The method of claim 33, wherein information collected the shopping task management service is searched.
